(19) United States
(12) Patent Application Publication
(10) Pub. No.: US 2015/0350919 A1
(43) Pub. Date: Dec. 3, 2015

(54) ADAPTATION OF ENHANCED INTER-CELL INTERFERENCE COORDINATION CONFIGURATION

(71) Applicant: QUALCOMM Incorporated, San Diego, CA (US)

(72) Inventors: Chirag Sureshbhai Patel, San Diego, CA (US); Mehmet Yavuz, San Diego, CA (US); Vinay Chande, San Diego, CA (US); Tamer Adel Kadous, San Diego, CA (US)

(73) Assignee: QUALCOMM Incorporated, San Diego, CA (US)

(21) Appl. No.: 14/288,239

(22) Filed: May 27, 2014

(51) Int. Cl. H04W 16/18; H04L 12/26; H04W 24/02

(52) U.S. Cl. CPC H04W 16/18; H04W 24/02; H04L 43/04

(57) ABSTRACT

In a wireless communication system, a cell may perform a method for adapting a long-term or short-term almost blank subframe (ABS) configuration, including determining, by the cell, a current neighbor cell deployment state, and adapting a long-term downlink ABS configuration of the cell based on the current neighbor cell deployment state. The current neighbor cell deployment state may include, for example, a number of neighbor cells, signal strengths of the neighbor cells, or a number of users being served in Cell Range Expansion (CRE), which may be determined using a Neighbor Listen module, receiving measurement reports from UEs, or receiving reports from small cell neighbors via a backhaul. Adapting the long-term downlink ABS configuration of the cell may include increasing a proportion of ABS-vacated resources in proportion to an change in neighbor cell deployment density, increasing neighbor cell signal strength, or increasing number of users served in CRE by neighbor cells.

### BACKGROUND

Aspects of the present disclosure relate generally to wireless communication systems, and more particularly, to adaptations of enhanced inter-cell interference coordination (eICIC) configuration in mixed macro and small cell wireless networks.

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. A base station may be, or may include, a macrocell or small cell. Small cells are characterized by having generally much lower transmit power than macrocells, and may often be deployed without central planning. In contrast, macrocells are typically installed at fixed locations as part of a planned network infrastructure, and cover relatively large areas.

The 3rd Generation Partnership Project (3GPP) Long Term Evolution (LTE) advanced cellular technology as an evolution of Global System for Mobile communications (GSM) and Universal Mobile Telecommunications System (UMTS). The LTE physical layer (PHY) provides a highly efficient way to convey both data and control information between base stations, such as an evolved Node Bs (eNBs), and mobile entities, such as UEs. In prior applications, a method for facilitating high bandwidth communication for multimedia has been single frequency network (SFN) operation. SFNs utilize radio transmitters, such as, for example, eNBs, to communicate with subscriber UEs.

Wireless networks have seen increasing addition of small, low-power cells. Mixed macro and small cell deployments on a shared carrier may use eICIC in the time domain to maximize offloading of traffic to idle cells and thereby enhance system capacity. The eICIC protocol is defined in 3GPP Rel. 10. When so used, eICIC may include configuring a number of almost blank subframes (ABS) that a macrocell uses to enable offloading of traffic to small cells without interfering with macrocell traffic on the same carrier. Typically, an operation and maintenance (OAM) node defines a long-term ABS configuration for the macrocell, which the macrocell may adapt in response to network load conditions. The long-term ABS configuration should be carefully selected to avoid under utilizing macrocell resources and overloading of small cells. However, current approaches may not effectively adapt the long-term ABS configuration for changes in deployment of small cells in a macrocell neighborhood. Since many small cells are deployed on an ad hoc basis on time scales much shorter than long-term ABS configuration operations, eICIC long-term ABS configuration at the cell may not be optimally adapted for actual neighbor cell (typically small-cell) deployment densities in the cell's neighborhood.

### SUMMARY

Methods, apparatus and systems for enhanced inter-cell interference coordination (eICIC) configuration in mixed macro and small cell wireless networks are described in detail in the detailed description, and certain aspects are summarized below. This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a cell may perform a method for adapting a long-term almost blank subframe (ABS) configuration of a cell. As used herein, an “ABS configuration” refers to a configuration for ABSs specified by the cell, used to configure downlink signaling from the cell. The cell may inform other receivers and transmitters in its radio neighborhood of the ABS configuration by transmitting, for example, a control signal from the cell. The method may include determining, by the cell, a current neighbor cell deployment state, and adapting a long-term downlink ABS configuration of the cell based on the current neighbor cell deployment state. The current neighbor cell deployment state may include at least one parameter selected from: a number of neighbor cells, signal strengths of the neighbor cells, or a number of users being served in Cell Range Expansion (CRE) by the neighbor cells. Determining the current neighbor cell deployment state may include at least one of at least one of: using a Neighbor Listen module, receiving measurement reports from UEs, or receiving reports from small cell neighbors via a backhaul. The adapting the long-term downlink ABS configuration of the cell may include increasing a proportion of ABS-vacated resources in proportion to at least one of: a change neighbor cell deployment density, increasing neighbor cell signal strength, or increasing number of users served in Cell Range Expansion (CRE) by neighbor cells. The neighbor cell deployment state may include information defining deployment of at least one small cell neighbor. The small cell may include, for example, a pico cell, femto cell or a home evolved Node B (HeNB) neighbor cell.

The method may further include, or a separate method may include, determining, by the cell, a current load condition of the cell, and adapting a short-term downlink ABS configuration of the cell based on the current load condition. A short-term configuration is a configuration that is applies to a substantially shorter time period than a long-term ABS configuration specified by an OAM node or other network entity. For example, a short-term configuration may be maintained for less than a day.

In related aspects, a wireless communication apparatus may be provided for performing any of the methods and aspects of the methods summarized above. An apparatus may include, for example, a processor coupled to a memory, wherein the memory holds instructions for execution by the processor to cause the apparatus to perform operations as described above. Certain aspects of such apparatus (e.g., hardware aspects) may be exemplified by a network entity, such as, for example, a base station, eNB, or small cell. In some aspects, a mobile entity and network entity may operate interactively to perform aspects of the technology as described herein. Similarly, an article of manufacture may be provided, including a computer-readable storage medium holding encoded instructions, which when executed by a processor, cause a network entity or access terminal to perform the methods and aspects of the methods as summarized above.

### BRIEF DESCRIPTION OF THE DRAWINGS

FIG. 1 is a block diagram conceptually illustrating an example of a telecommunications system.

FIG. 2 is a block diagram conceptually illustrating an example of a down link frame structure in a telecommunications system, including almost-blank subframes.

FIG. 3 is a block diagram conceptually illustrating is a block diagram conceptually illustrating a design of a base station/eNB and a UE configured according to one aspect of the present disclosure.

FIG. 4 illustrates a methodology for adapting a long-term ABS configuration of a cell.

FIG. 5 illustrates a methodology for adapting a short-term ABS configuration of a cell, which may be used alone, or in combination with, the methodology of FIG. 4.

FIG. 6 illustrates an embodiment of an apparatus for adapting a long-term ABS configuration of a cell, in accordance with the methodology of FIG. 4.

FIG. 7 illustrates an embodiment of an apparatus for adapting a short-term ABS configuration of a cell, in accordance with the methodology of FIG. 5.

### DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

New approaches for adapting an eICIC configuration in mixed macro and small cell wireless networks may include adapting a long-term ABS configuration of an aggressor cell (typically but not necessarily a macrocell) based on the cell detecting, and/or receiving reports from neighbor cells or UEs regarding, a current neighbor cell deployment state. As used herein, an “aggressor cell” is one that employs ABS on the downlink to avoid interfering with downlink transmissions of a “victim cell.” Conversely, the “victim cell” transmits on the downlink using ABS resources vacated by the aggressor cell. A small cell, like a macrocell, may be a victim cell or aggressor cell, depending on specific circumstances.

The current neighbor cell deployment state may be defined by parameters including but not limited to a number of detected neighbors, respective detected signal strengths of the detected neighbors, or number of users being served in Cell Range Expansion (CRE) vs. number of users served in non-CRE. In a separate aspect, short-term ABS configuration of the aggressor cell may be adapted based on dynamic cell load conditions. Long-term configuration adaptation may include adaptations that are static over relatively long time frames, for example about a day or more. Conversely, short term configuration adaptations may include those that are static over shorter time frames, for example less than a day, such as adaptations used for specific user sessions.

In general, ABS configuration may be adapted between specified ranges. For example, for 3GPP Rel. 10, ABS for cells not using Voice over Internet Protocol (VoIP), downlink resources vacated using ABS may be in the range of ⅛ to ⅞ of total bandwidth. For further example, for cells using VoIP, downlink resources vacated using ABS may be in the range of ⅛ to 4/8 of total bandwidth.

An aggressor cell may perform long-term ABS configuration adaptation by, for example, increasing or decreasing downlink resources vacated using ABS in proportion to a number of small cells deployed in the aggressor cell's coverage area. Such number may represent a deployment density, for example, a number of cells per unit of aggressor cell coverage area. For example, the aggressor cell may adapt default long-term ABS-vacated resources in proportion to deployment density, between a floor (minimum ABS configuration) and a ceiling (maximum ABS configuration) with the proportion of vacated resources increasing with increasing density.

In addition, or in the alternative, the aggressor cell may adapt long-term ABS-vacated resources in proportion to detected or reported signal strength of cells within the aggressor cell's coverage area. For example, the aggressor cell may adapt long-term default ABS-vacated resources in proportion to neighbor cell signal strength, between a floor (minimum ABS configuration) and a ceiling (maximum ABS configuration) with the proportion of vacated resources increasing with increasing aggregate neighbor signal strength.

The aggressor cell may determine deployment density or signal strength (e.g., RSSI, RSRP) of cells within a coverage of a macrocell, for example by using a Neighbor Listen module, receiving measurement reports from UEs, or receiving reports from small cell neighbors via a backhaul.

In further addition or alternative, the aggressor cell may adapt long-term ABS-vacated resources in proportion to a number of users being served in Cell Range Expansion (CRE) vs. number of users served in non-CRE. For example, the aggressor cell may adapt default long-term ABS-vacated resources in proportion to a number if users served in CRE by one or more small cells in a macro coverage area, between a floor (minimum ABS configuration) and a ceiling (maximum ABS configuration) with the proportion of vacated resources increasing with increasing aggregate number of users being served in CRE.

An aggressor cell may perform short-term ABS configuration adaptation by, for example, increasing or decreasing downlink resources vacated using ABS in proportion to load conditions. Load conditions may include, for example, a number of users being served by the aggressor cell or downlink aggregate data rate demanded by current cell users. The aggressor cell may adapt vacation resources on a short-term basis in proportion to its load conditions, for example as a portion of a maximum long-term ABS configuration between 0-100% plus a minimum ABS configuration which may be zero or some non-zero amount (e.g., ⅛), wherein the portion decreases with increasing load conditions.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. The cdma2000 technology is covered by IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). The cdma2000 and UMB technologies are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

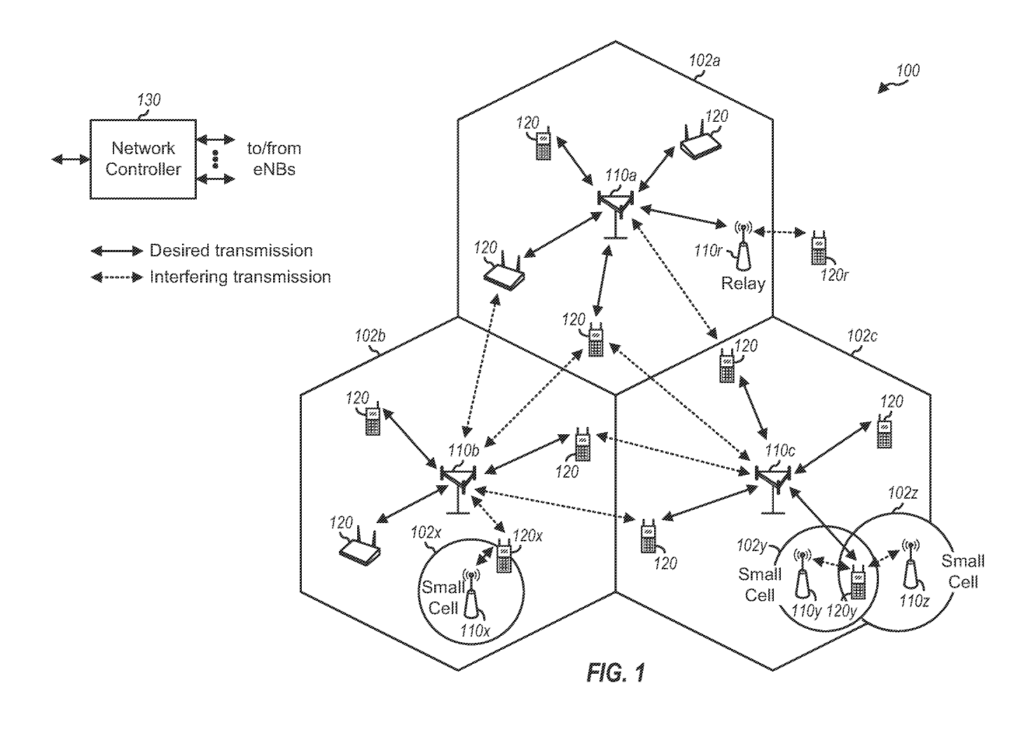

FIG. 1 shows a wireless communication network 100, which may be an LTE network. The wireless network 100 may include a number of eNBs 110 and other network entities. An eNB may be a station that communicates with the UEs and may also be referred to as a base station, a Node B, an access point, or other term. Each eNB 110a, 110b, 110c may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell or a small cell (e.g., a pico cell or a femto cell) and/or other types of cell. A macro cell may cover a relatively large geographic area (e.g., several kilometers in radius) and may allow unrestricted access by UEs with service subscription. A type of small cell sometimes referred to as a “pico cell” may cover a relatively small geographic area and may allow unrestricted access by UEs with service subscription. A type of small cell sometimes referred to as a “femto cell” may cover a relatively small geographic area (e.g., a home) and may allow restricted access by UEs having association with the small cell (e.g., UEs in a Closed Subscriber Group (CSG), UEs for users in the home, etc.). An eNB for a macro cell may be referred to as a macro eNB. An eNB for a small cell may be referred to as a small cell eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be small cell eNBs for the small cells 102y and 102z, respectively. An eNB may support one or multiple (e.g., three) cells. As used herein, a small cell means a cell characterized by having a transmit power substantially less than each macro cell in the network with the small cell, for example low-power access nodes such as defined in 3GPP Technical Report (T.R.) 36.932 section 4.

The wireless network 100 may also include relay stations 110r. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, small cell eNBs, relays, etc. These different types of eNBs may have different transmit power levels, different coverage areas, and different impact on interference in the wireless network 100. For example, macro eNBs may have a high transmit power level (e.g., 5 to 20 Watts) whereas small cell eNBs and relays may have a lower transmit power level (e.g., 0.1 to 2 Watts).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, a smart phone, etc. A UE may be a cellular phone, a personal digital assistant (PDA), a wireless modem, a wireless communication device, a handheld device, a laptop computer, a cordless phone, a wireless local loop (WLL) station, or other mobile entities. A UE may be able to communicate with macro eNBs, small cell eNBs, relays, or other network entities. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

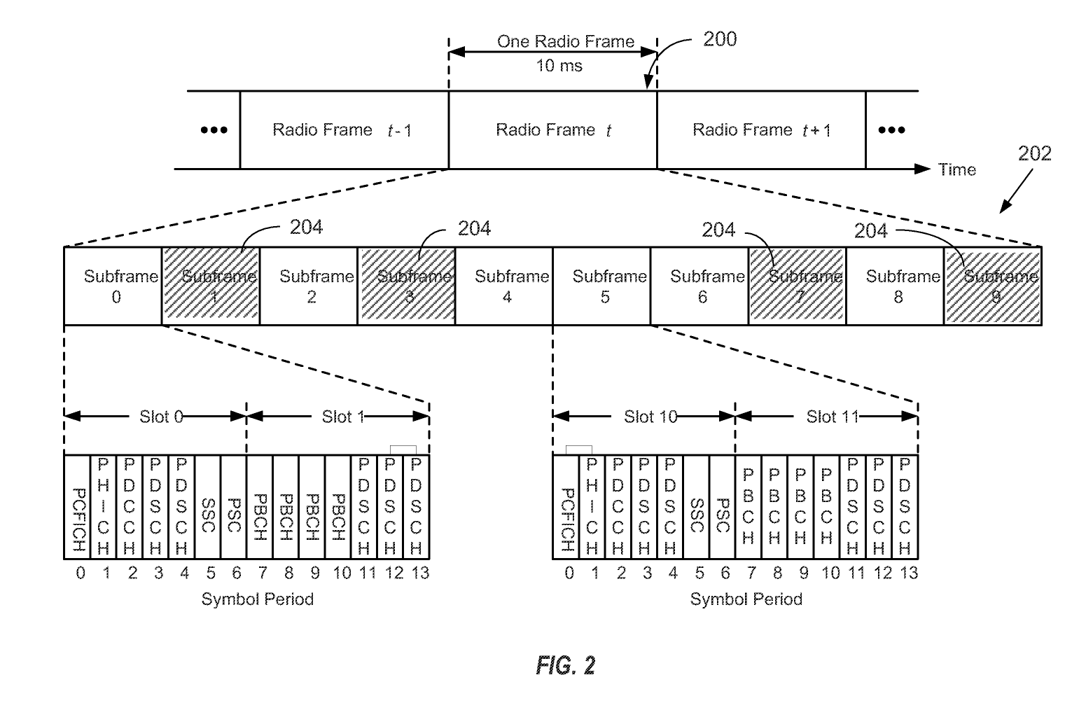

FIG. 2 shows a down link frame structure used in LTE. The transmission timeline for the downlink may be partitioned into units of radio frames, e.g., the radio frame 200. Each radio frame may have a predetermined duration (e.g., 10 milliseconds (ms)) and may be partitioned into an integral number (e.g., 10) subframes 202 with indices of 0 through 9. Each subframe may include two slots. Each radio frame may thus include 20 slots with indices of 0 through 19. Each slot may include L symbol periods, e.g., 7 symbol periods for a normal cyclic prefix (CP), as shown in FIG. 2, or 6 symbol periods for an extended cyclic prefix. The normal CP and extended CP may be referred to herein as different CP types. The 2 L symbol periods in each subframe may be assigned indices of 0 through 2 L−1. The available time frequency resources may be partitioned into resource blocks. Each resource block may cover N subcarriers (e.g., 12 subcarriers) in one slot.

In eICIC, an aggressor may leave a predetermined pattern of downlink subframes almost blank of data and control signals, i.e., the “Almost Blank Subframes” (ABSs) 204. As used herein, the “ABS configuration” refers to a defined pattern of ABSs in a radio frame. For example, in downlink radio frame 200, the ABS configuration 204 consists of subframes 1, 3, 9 and 9. The number of blank subframes in an ABS configuration may be changed on a short-term (e.g., less than 24 hour) basis in response to current load conditions. The number of blank subframes in an ABS configuration may be changed on a long-term (e.g., greater than 24 hour) basis in response to a cells neighbor cell deployment state.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in only a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical HARQ Indicator Channel (PHICH) and a Physical Downlink Control Channel (PDCCH) in the first M symbol periods of each subframe (M=3 in FIG. 2). The PHICH may carry information to support hybrid automatic retransmission (HARQ). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available. Standards pertaining to use of ABSs call for omitting most or all of these control signals from the ABSs.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs. Most or all of these control signals may be omitted from an ABS.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH. In an ABS, most or all of these resource elements are empty.

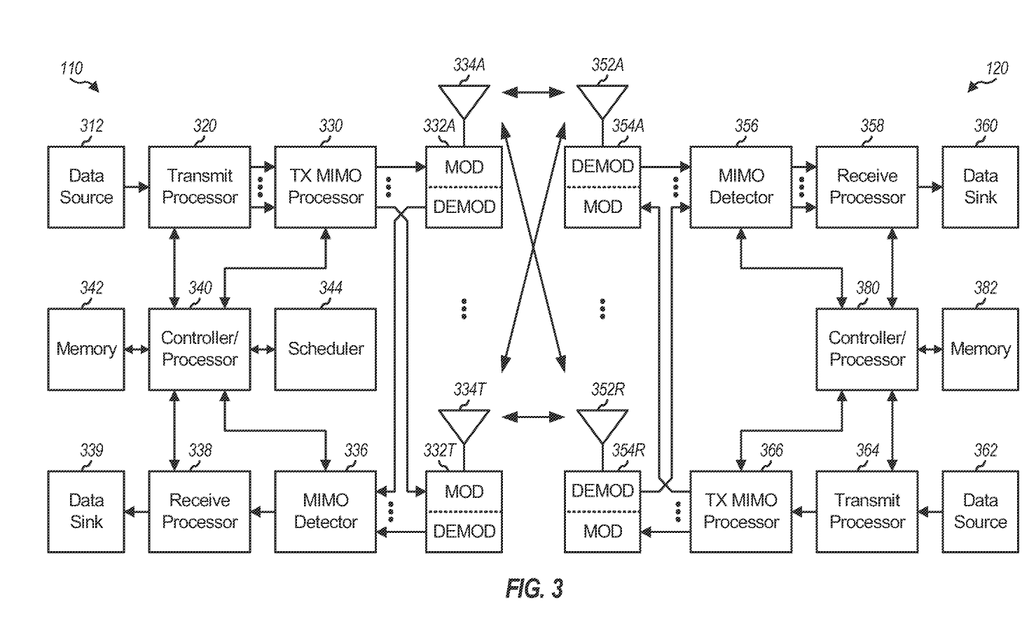

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the modulators 354a through 354r (e.g., for SC-FDM, etc.), and transmitted to the base station 110. At the base station 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

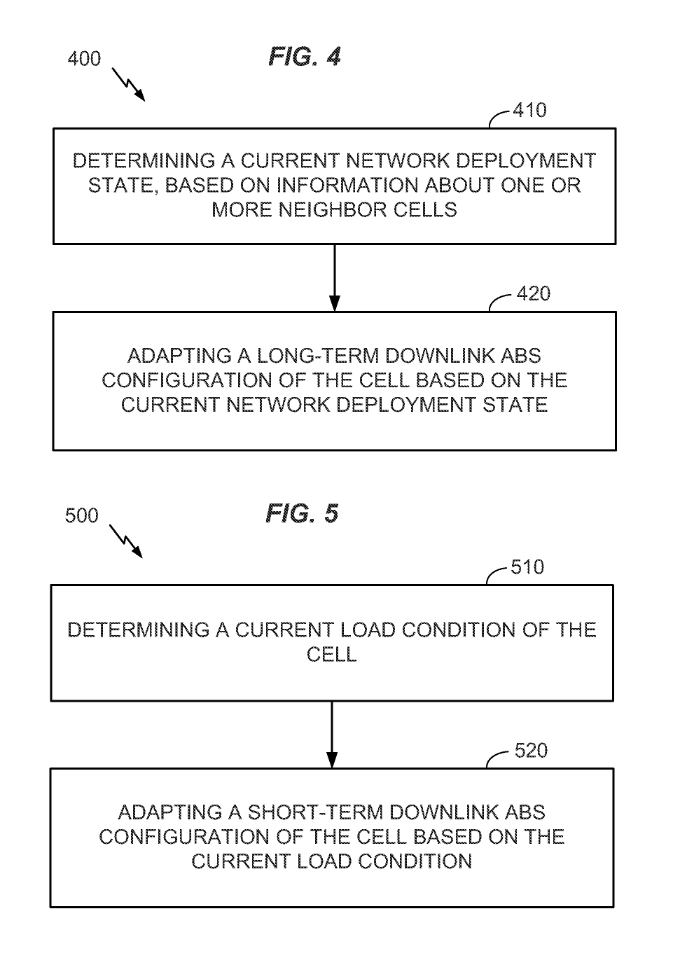

The controllers/processors 340 and 380 may direct the operation at the base station 110 and the UE 120, respectively. The processor 380 and/or other processors and modules at the UE 120 may also perform or direct the execution of the functional blocks illustrated in FIGS. 4 and 5, and/or other processes for the techniques described herein. The memories 342 and 382 may store data and program codes for the base station 110 and the UE 120, respectively. A scheduler 344 may schedule UEs for data transmission on the downlink and/or uplink.

In one configuration, the UE 120 for wireless communication includes means for detecting interference from an interfering base station during a connection mode of the UE, means for selecting a yielded resource of the interfering base station, means for obtaining an error rate of a physical downlink control channel on the yielded resource, and means, executable in response to the error rate exceeding a predetermined level, for declaring a radio link failure. In one aspect, the aforementioned means may be the processor(s), the controller/processor 380, the memory 382, the receive processor 358, the MIMO detector 356, the demodulators 354a, and the antennas 352a configured to perform the functions recited by the aforementioned means. In another aspect, the aforementioned means may be a module or any apparatus configured to perform the functions recited by the aforementioned means.

### Example Methodologies and Apparatus

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored as encoded instructions and/or data on an article of manufacture to facilitate transporting and transferring such methodologies to various devices. Those skilled in the art will understand and appreciate that a method could alternatively be represented as a series of interrelated states or events, such as in a state diagram.

FIG. 4 shows a method 400 for adapting a long-term ABS configuration of a cell. The cell may be in a neighborhood including one or more small cells comprising low power base stations (e.g., femto node, pico node, Home Node B, etc.) of a wireless communications network. The cell may be a macrocell, or a microcell. The method 400 may include, at 410, determining a current neighbor cell deployment state. In an aspect, the current neighbor cell deployment state may include at least one parameter selected from: a number of neighbor cells, signal strengths of the neighbor cells, or a number of users being served in Cell Range Expansion (CRE) by the neighbor cells. The cell deployment state may include a set of such parameters that partly or completely defines available parameters for neighbor cells that are in the radio neighborhood of the subject cell. In an aspect, the neighbor cell deployment state may include information defining deployment of a small cell neighbor.

The operation 410 may further include additional operations or execution of algorithms, for example, at least one of: using a Neighbor Listen module, receiving measurement reports from UEs, or receiving reports from small cell neighbors via a backhaul. For example, an aggressor cell may determine deployment density or signal strength (e.g., RSSI, RSRP) of cells within a coverage of a macrocell, for example by using a Neighbor Listen module, receiving measurement reports from UEs, or receiving reports from small cell neighbors via a backhaul.

Determining the neighbor cell configuration state 410 may be repeated periodically, for example, hourly or daily. In addition, or in the alternative, determining the neighbor cell configuration state 410 may be triggered by a predefined event, for example a power-up event or detection of a new beacon, interference, or other signal from or related to the cell's radio neighborhood.

The method 400 may further include, at 420, adapting a long-term downlink ABS configuration of the cell based on the current neighbor cell deployment state. This may include, for example, setting a long-term or default value of the cell's ABS configuration based on (e.g., in response to) the determined current neighbor cell deployment state. In general, the cell may adapt ABS configuration between specified ranges. For example, for 3GPP Rel. 10, ABS for cells not using Voice over Internet Protocol (VoIP), downlink resources vacated using ABS may be in the range of ⅛ to ⅞ of total bandwidth. For further example, for cells using VoIP, downlink resources vacated using ABS may be in the range of ⅛ to 4/8 of total bandwidth.

Adapting the long-term downlink ABD configuration 420 may include adjusting (e.g., increasing or decreasing) a proportion of ABS-vacated resources in proportion to at least one of: a change in neighbor cell deployment density (for example, increase or decrease in the desity), increasing neighbor cell signal strength, or increasing number of users served in Cell Range Expansion (CRE) by neighbor cells. For example, long-term ABS configuration adaptation 420 by an aggressor cell may include increasing or decreasing downlink resources vacated using ABS in proportion to a number of small cells deployed in the aggressor cell's coverage area, representing a neighbor cell deployment state. The number may be in the form of a deployment density, for example, a number of cells per unit of aggressor cell coverage area. For example, in an aspect the aggressor cell may adapt default long-term ABS-vacated resources in proportion to deployment density, between a floor (minimum ABS configuration) and a ceiling (maximum ABS configuration) with the proportion of vacated resources increasing with increasing density, according to a linear proportional algorithm bounded by thresholds.

In addition, or in the alternative, the aggressor cell may adapt long-term ABS-vacated resources 420 in proportion to detected or reported signal strength of cells within the aggressor cell's coverage area. For example, the aggressor cell may adapt long-term default ABS-vacated resources in proportion to neighbor cell signal strength, between a floor (minimum ABS configuration) and a ceiling (maximum ABS configuration) with the proportion of vacated resources increasing with increasing aggregate neighbor signal strength.

For further example, the aggressor cell may adapt long-term ABS-vacated resources 420 in proportion to a number of users being served in Cell Range Expansion (CRE) vs. number of users served in non-CRE. For example, the aggressor cell may adapt default long-term ABS-vacated resources in proportion to a number if users served in CRE by one or more small cells in a macro coverage area, between a floor (minimum ABS configuration) and a ceiling (maximum ABS configuration) with the proportion of vacated resources increasing with increasing aggregate number of users being served in CRE.

In a separate aspect, as illustrated by FIG. 5, short-term ABS configuration of the aggressor cell may be adapted based on dynamic cell load conditions. Long-term configuration adaptation may include adaptations that are static over relatively long time frames, for example about a day or more. Conversely, short term configuration adaptations may include those that are static over shorter time frames, for example less than a day, such as adaptations used for specific user sessions. The operations 500 illustrated by FIG. 5 may be performed by an aggressor cell as part of, or in combination with, the method 400. In the alternative, the operations 500 may be performed by an aggressor cell as a separate method independently of method 400.

The operations or method 500 may include, at 510, determining a current load condition by the aggressor cell. Load conditions may include, for example, a number of users being served by the aggressor cell or downlink aggregate data rate demanded by current cell users. The aggressor cell may determine and monitor its own load conditions by any suitable method, including comparing current load (e.g., user count or aggregate downlink data rate) to a baseline, or to one or more thresholds.

At 520, an aggressor cell may perform short-term ABS configuration adaptation mase on the current load condition determined at 510. For example, the aggressor cell may increase or decrease a proportion of downlink resources vacated using ABS, in proportion to a measure of load conditions such as percentage of full capacity. The aggressor cell may adapt the vacating of resources on a short-term basis in proportion to its load conditions, for example as a portion of a maximum long-term ABS configuration between 0-100% plus a minimum ABS configuration which may be zero or some non-zero amount (e.g., ⅛). For example, the cell may decrease the ABS portion with increasing load conditions, and vice-versa.

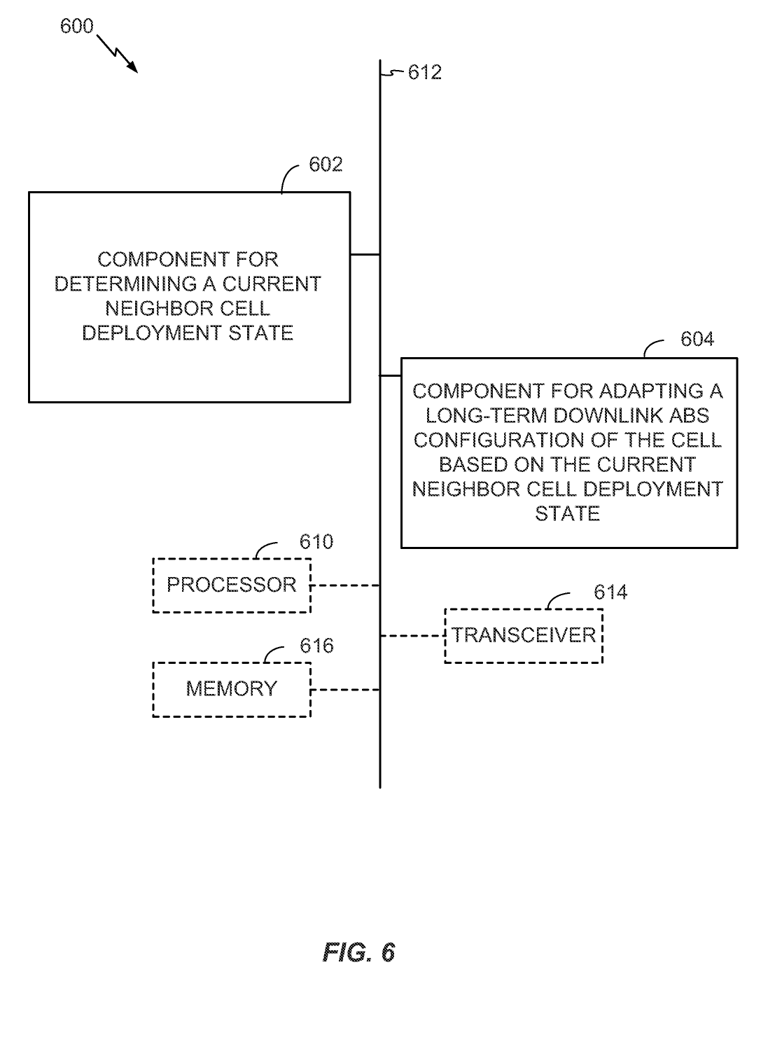

With reference to FIG. 6, there is depicted an example of an apparatus 600 that may be configured as a cell in a wireless network, or as a processor or similar device for use within the cell, disposed as an aggressor cell. The apparatus 600 may include functional blocks that can represent functions implemented by a processor, software, hardware, or combination thereof (e.g., firmware).

As illustrated, in one embodiment, the apparatus 600 may include an electrical component or module 602 for determining a current neighbor cell deployment state. For example, the electrical component 602 may include at least one control processor coupled to a transceiver or the like and to a memory with instructions for detecting one or more neighbor signals, and processing the signals to obtain a numerical assessment of a neighbor state. The component 602 may be, or may include, a means for determining a current neighbor cell deployment state. Said means may include the control processor executing any one or more of the algorithms for determining a current neighbor cell deployment state as described in connection with FIG. 4.

The apparatus 600 may include an electrical component 604 for adapting a long-term downlink ABS configuration of the cell based on the current neighbor cell deployment state. For example, the electrical component 604 may include at least one control processor coupled to a transceiver or the like and to a memory holding instructions for changing a proportion of ABSs based on a value of the deployment state. The component 604 may be, or may include, a means for adapting a long-term downlink ABS configuration of the cell based on the current neighbor cell deployment state. Said means may include the control processor executing any one or more of the algorithms for adapting a long-term ABS configuration as described above in connection with FIG. 4.

The apparatus 600 may include similar electrical components for performing any or all of the additional operations 500 described in connection with FIG. 4, which for illustrative simplicity are not shown in FIG. 6.

In related aspects, the apparatus 600 may optionally include a processor component 610 having at least one processor, in the case of the apparatus 600 configured as a network entity. The processor 610, in such case, may be in operative communication with the components 602-604 or similar components via a bus 612 or similar communication coupling. The processor 610 may effect initiation and scheduling of the processes or functions performed by electrical components 602-604. The processor 610 may encompass the components 602-604, in whole or in part. In the alternative, the processor 610 may be separate from the components 602-604, which may include one or more separate processors.

In further related aspects, the apparatus 600 may include a radio transceiver component 614. A stand alone receiver and/or stand alone transmitter may be used in lieu of or in conjunction with the transceiver 614. In the alternative, or in addition, the apparatus 600 may include multiple transceivers or transmitter/receiver pairs, which may be used to transmit and receive on different carriers. The apparatus 600 may optionally include a component for storing information, such as, for example, a memory device/component 616. The computer readable medium or the memory component 616 may be operatively coupled to the other components of the apparatus 600 via the bus 612 or the like. The memory component 616 may be adapted to store computer readable instructions and data for performing the activity of the components 602-604, and subcomponents thereof, or the processor 610, the additional aspects 500, or the methods disclosed herein. The memory component 616 may retain instructions for executing functions associated with the components 602-604. While shown as being external to the memory 616, it is to be understood that the components 602-604 can exist within the memory 616.

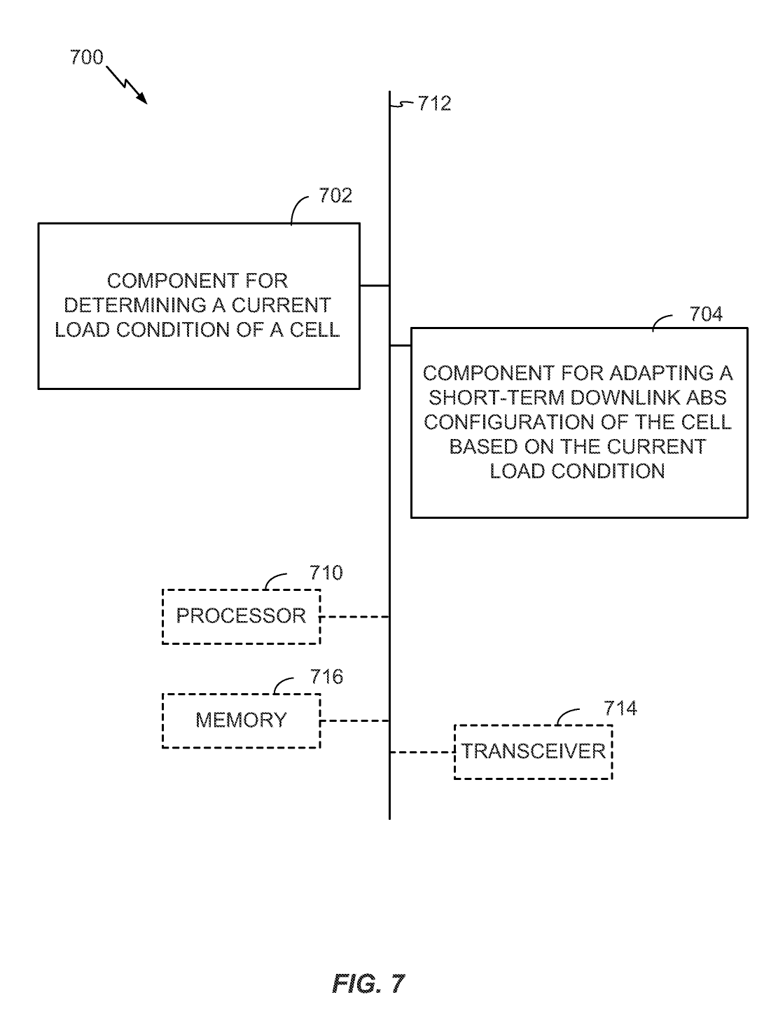

For further example, with reference to FIG. 7, there depicted an apparatus 700 that may be configured as a cell in a wireless network, or as a processor or similar device for use within the cell, disposed as an aggressor cell. The apparatus 700 may include functional blocks that can represent functions implemented by a processor, software, hardware, or combination thereof (e.g., firmware).

As illustrated, in one embodiment, the apparatus 700 may include an electrical component or module 702 for determining a current load condition of the aggressor cell. For example, the electrical component 702 may include at least one control processor coupled to a transceiver or the like and to a memory with instructions for tracking user connections and/or downlink data rates, and processing the tracked information to obtain a numerical assessment of current cell load. The component 702 may be, or may include, a means for determining a current load condition of the cell. Said means may include the control processor executing any one or more of the algorithms for determining a current load condition of the aggressor cell as described in connection with FIG. 5.

The apparatus 700 may include an electrical component 704 for adapting a short-term downlink ABS configuration of the cell based on the current load condition. For example, the electrical component 704 may include at least one control processor coupled to a transceiver or the like and to a memory holding instructions for changing a proportion of ABSs based on a value of the load condition. The component 704 may be, or may include, a means for adapting a short-term downlink ABS configuration of the cell based on the current load condition. Said means may include the control processor executing any one or more of the algorithms for adapting a short-term ABS configuration as described above in connection with FIG. 5.

In related aspects, the apparatus 700 may optionally include a processor component 710 having at least one processor, in the case of the apparatus 700 configured as a network entity. The processor 710, in such case, may be in operative communication with the components 702-704 or similar components via a bus 712 or similar communication coupling. The processor 710 may effect initiation and scheduling of the processes or functions performed by electrical components 702-704. The processor 710 may encompass the components 702-704, in whole or in part. In the alternative, the processor 710 may be separate from the components 702-704, which may include one or more separate processors.

In further related aspects, the apparatus 700 may include a radio transceiver component 714. A stand alone receiver and/or stand alone transmitter may be used in lieu of or in conjunction with the transceiver 714. In the alternative, or in addition, the apparatus 700 may include multiple transceivers or transmitter/receiver pairs, which may be used to transmit and receive on different carriers. The apparatus 700 may optionally include a component for storing information, such as, for example, a memory device/component 716. The computer readable medium or the memory component 716 may be operatively coupled to the other components of the apparatus 700 via the bus 712 or the like. The memory component 716 may be adapted to store computer readable instructions and data for performing the activity of the components 702-704, and subcomponents thereof, or the processor 710, or the methods disclosed herein. The memory component 716 may retain instructions for executing functions associated with the components 702-704. While shown as being external to the memory 716, it is to be understood that the components 702-704 can exist within the memory 716.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available non-transitory media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually encode data magnetically, while “discs” customarily refer to media encoded optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and features disclosed herein.

What is claimed is:

1. A method for adapting a long-term almost blank subframe (ABS) configuration of a cell, the method comprising:
determining, by the cell, a current neighbor cell deployment state; and
adapting a long-term downlink ABS configuration of the cell based on the current neighbor cell deployment state.

2. The method of claim 1, wherein the current neighbor cell deployment state includes at least one parameter selected from: a number of neighbor cells, signal strengths of the neighbor cells, or a number of users being served in Cell Range Expansion (CRE) by the neighbor cells.

3. The method of claim 1, wherein the determining the current neighbor cell deployment state comprises at least one of: using a Neighbor Listen module, receiving measurement reports from UEs, or receiving reports from small cell neighbors via a backhaul.

4. The method of claim 1, wherein the adapting the long-term downlink ABS configuration of the cell comprises increasing a proportion of ABS-vacated resources in proportion to at least one of: change in neighbor deployment cell density, increasing neighbor cell signal strength, or increasing number of users served in Cell Range Expansion (CRE) by neighbor cells.

5. The method of claim 1, further comprising:
determining, by the cell, a current load condition of the cell; and
adapting a short-term downlink ABS configuration of the cell based on the current load condition.

6. The method of claim 1, wherein the neighbor cell deployment state comprises information defining deployment of a small cell neighbor.

7. An apparatus for wireless communication, the apparatus comprising:
means for determining a current neighbor cell deployment state;
means for adapting a long-term downlink almost blank subframe (ABS) configuration of the cell based on the current neighbor cell deployment state.

8. An apparatus for wireless communication, comprising:
at least one processor configured for determining a current neighbor cell deployment state, and adapting a long-term downlink almost blank subframe (ABS) configuration of the cell based on the current neighbor cell deployment state; and
a memory coupled to the at least one processor for storing data.

9. The apparatus of claim 8, wherein the processor is further configured for determining the current neighbor cell deployment state including at least one parameter selected from: a number of neighbor cells, signal strengths of the neighbor cells, or a number of users being served in Cell Range Expansion (CRE) by the neighbor cells.

10. The apparatus of claim 8, wherein the processor is further configured for determining the current neighbor cell deployment state by at least one of: using a Neighbor Listen module, receiving measurement reports from UEs, or receiving reports from small cell neighbors via a backhaul.

11. The apparatus of claim 8, wherein the processor is further configured for adapting the long-term downlink ABS configuration of the cell by increasing a proportion of ABS-vacated resources in proportion to at least one of: change in neighbor cel deployment density, increasing neighbor cell signal strength, or increasing number of users served in Cell Range Expansion (CRE) by neighbor cells.

12. The apparatus of claim 8, wherein the processor is further configured for:
determining a current load condition of the cell; and
adapting a short-term downlink almost blank subframe (ABS) configuration of the cell based on the current load condition.

13. The apparatus of claim 8, wherein the processor is further configured for determining the neighbor cell deployment state based on information defining deployment of a small cell neighbor.

14. A non-transitory computer-readable medium holding instructions, that when executed by a processor, cause a computer to:
determine a current neighbor cell deployment state; and
adapt a long-term downlink almost blank subframe (ABS) configuration of the cell based on the current neighbor cell deployment state.

15. The non-transitory computer-readable medium of claim 14, holding further instructions for determining the current neighbor cell deployment state including at least one parameter selected from: a number of neighbor cells, signal strengths of the neighbor cells, or a number of users being served in Cell Range Expansion (CRE) by the neighbor cells.

16. The non-transitory computer-readable medium of claim 14, holding further instructions for determining the current neighbor cell deployment state by at least one of: using a Neighbor Listen module, receiving measurement reports from UEs, or receiving reports from small cell neighbors via a backhaul.

17. The non-transitory computer-readable medium of claim 14, holding further instructions for adapting the long-term downlink ABS configuration of the cell by increasing a proportion of ABS-vacated resources in proportion to at least one of: change in neighbor cel deployment density, increasing neighbor cell signal strength, or increasing number of users served in Cell Range Expansion (CRE) by neighbor cells.

18. The non-transitory computer-readable medium of claim 14, holding further instructions for:
determining a current load condition of the cell; and
adapting a short-term downlink almost blank subframe (ABS) configuration of the cell based on the current load condition.

19. The apparatus of claim 8, wherein the processor is further configured for determining the neighbor cell deployment state based on information defining deployment of a small cell neighbor.

20. A method for adapting a short-term almost blank subframe (ABS) configuration of a cell, the method comprising:
determining, by the cell, a current load condition of the cell; and
adapting a short-term downlink ABS configuration of the cell based on the current load condition.

21. An apparatus for adapting a short-term almost blank subframe (ABS) configuration of a cell, the apparatus comprising:
means for determining a current load condition of the cell; and
means for adapting a short-term downlink ABS configuration of the cell based on the current load condition.

22. An apparatus for adapting a short-term almost blank subframe (ABS) configuration of a cell, comprising:
at least one processor configured for determining a current load condition of the cell, and adapting a short-term downlink ABS configuration of the cell based on the current load condition; and
a memory coupled to the at least one processor for storing data.

23. A non-transitory computer-readable medium holding instructions, that when executed by a processor, cause a computer to:
determine a current load condition of a cell; and
adapt a short-term downlink almost blank subframe (ABS) configuration of the cell based on the current load condition.
